(19) United States
(12) Patent Application Publication
(10) Pub. No.: US 2022/0292617 A1
(43) Pub. Date: Sep. 15, 2022

(54) Blockchain-Enabled Advanced Shipment Notice For Additive Manufacturing Supply Chain

(71) Applicant: Ford Global Technologies, LLC, Dearborn, MI (US)

(72) Inventors: Matthew Cassoli, Dearborn, MI (US); Pramita Mitra, West Bloomfield, MI (US); Spencer White, Dearborn, MI (US); Josh Fodale, Ypsilanti, MI (US); Evan Squires, Dearborn, MI (US)

(73) Assignee: Ford Global Technologies, LLC, Dearborn, MI (US)

(21) Appl. No.: 17/201,007

(22) Filed: Mar. 15, 2021

(51) Int. Cl. G06Q 50/04; G06Q 10/08; G06F 16/27

(52) U.S. Cl. CPC G06Q 50/04; G06Q 10/0837; G06F 16/27; G06Q 2220/18

(57) ABSTRACT

Blockchain-enabled advanced shipment notice for additive manufacturing supply chain is disclosed herein. An example method includes generating a digital supply item associated with a product model for a part, encrypting the digital supply item, generating an additive manufacturing policy for the part, and adding the digital supply item and the additive manufacturing policy to a blockchain ledger. A supplier can authorize a print job for the part, decrypt the digital supply item from the blockchain ledger, and print the part using the digital supply item on a three-dimensional printer, according to the additive manufacturing policy.

### BACKGROUND

An Advanced Shipment Notice (ASN) is a document that provides details about a pending delivery of goods. One example of when an ASN may be sent is when a supplier sends a shipment of a product to a customer, for instance, an Original Equipment Manufacturer (OEM) assembler or manufacturing facility. An ASN typically provides details on when the order is shipped, which items/goods are being shipped, and how many units of each item are being shipped. It includes characteristic features of the shipment such as its weight, number of boxes, and an account of how the units within the shipment are packaged. The ASN also includes the shipment's mode of transportation and details about the carrier.

The ASN has several functions, with the least of which being notifying the customer that the shipment is on the way. It is used to the advantage of a customer for ensuring order and inventory visibility, tightening the supply chain, and driving process efficiency. In an OEM assembly, for instance, the ASN enables advanced workflow planning, starting with quicker unloading and sorting at the receiving dock, staging parts for installation, and moving final verification at end of the line.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 is a workflow of the present disclosure executed in the context of the architecture of FIG. 1.

FIG. 3 is a flowchart of an example method where an ASN is utilized.

FIGS. 4A-4D collectively illustrates code for an example ASN Smart Contract.

FIG. 4E depicts code for another example ASN Smart Contract for matching paired parts.

FIG. 5 illustrates an example use case where matching pairs of parts can be effectively managed using aspects of the present disclosure.

FIG. 6 illustrates an example of matching paired parts specified in an ASN Smart Contract.

FIG. 7 illustrates another example of matching paired parts specified in an ASN Smart Contract.

FIG. 8 is a flowchart example method of the present disclosure.

### DETAILED DESCRIPTION

### Overview

Disclosed herein are systems and methods that leverage blockchain to capture data pertaining to an Advance Shipment Notice (ASN) in a vehicle manufacture process. The systems and methods disclosed herein may be configured to auto-generate an ASN using a blockchain smart contract at an end of the supplier workflow. This advantageously reduces cost by no longer having to pay for the Electronic Data Interchange (EDI) solution now disintermediated by blockchain. The systems and methods also increase trust and transparency, as the ASN is computed based on secure, verifiable data from the blockchain. The smart contract can also make additional checks to assist in part acceptance/rejection decision making, as well as provide additional checks assisting for matching pairs of parts based on their quality data.

An example method disclosed herein may capture information about the manufacture of vehicle parts during the actual manufacturing processing of the parts. A first use case may involve, for each vehicle part, the ASN Smart Contract (“ASN SC”) being used to perform two checks and to flag an item with an accept/reject status. First, in-process parameters and a quality check can be performed. Blockchain events can be recorded for in-process monitoring parameters and quality check parameters.

It will be understood that a supplier may not add any parts to the shipment that failed the quality check. However, there could be parts that pass the quality check but also have an anomaly in a printing condition (captured by a manufacturing failure blockchain event) or in the quality check being conducted multiple times (if mistakes were made initially). These conditions may be flagged as being accepted with concern, to better assist troubleshooting during the assembly and in the field.

Second, a digital supply item (DSI) revocation check can be performed. A DSI is an encrypted digital part that includes at least one of CAD file(s) and printing instructions (G-Code), that is shared with the supplier for OEM designed parts. The encryption key is shared with the supplier (for decryption of the DSI) off-chain (i.e., outside of blockchain). If the part was printed after the DSI for the part is revoked by the OEM (for example in case a new version release) then the part may be rejected as negotiated in the contract even if it passed the quality check at the supplier. If the part was printed before the DSI revocation happened, it still does not guarantee acceptance, since the OEM may not want to accept parts from the supplier's inventory. In this case, there may be an external process that a blockchain smart contract can interact with which would maintain a list of current DSI version(s) which would be accepted. For each part printed before DSI revocation, the ASN SC may verify its DSI version number with the external process, and flag accept/reject status.

A second use case may involve checks for sorting high-quality parts. Parts that fit an additional subset of criteria inside the quality check are called super parts. It is beneficial to flag the high-quality parts on the ASN by their serial number, so that these high-quality parts may be sorted and staged for various reasons, such as sending to low volume luxury vehicles or custom order-to-build vehicle and so forth. In one example, a custom filter can be used to flag high-quality parts, and this filter can be shared with the supplier, enabling the supplier to assist with the sorting (i.e., prepare the shipment in the sorted order such as super parts in a particular container, or truck, or on top of a container, and so forth) if properly incentivized. In another example, the custom filter is not shared with the supplier and instead applied by a second smart contract when the shipment is received. For example, a super part can have a specific and narrow tolerance compared to another part that is used along with the part in an assembly. Use case examples are provided herein.

A third use case may involve matching pairs of parts. Without a system or method to track where parts were located within a tolerance zone, an interface tolerance system may operate in a less-than-optimal manner, this necessitates engineering for worst case fits within the scope of possible matched parts pairs. Designers must consider worst case matched pairs for the purposes of analyzing risk of parts being broken during service, expected lifecycle wear and lifetime, and customer experience and perception of functionality.

### Illustrative Embodiments

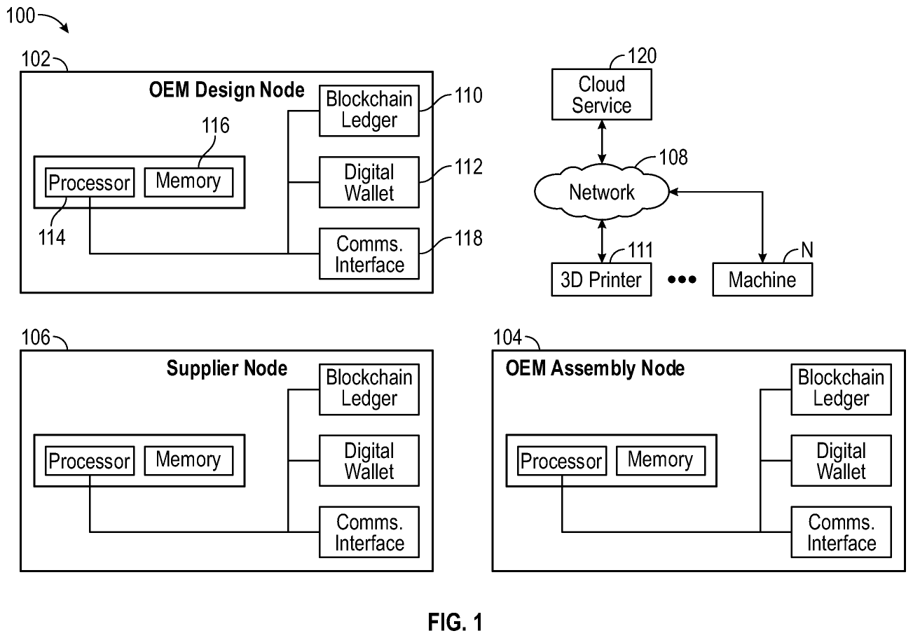

Turning now to the drawings, FIG. 1 depicts an illustrative architecture 100 in which techniques and structures of the present disclosure may be implemented. The architecture 100 can include OEM design node 102, OEM assembly node 104, a supplier node 106, and a network 108. Some or all of these components in the architecture 100 can communicate with one another using the network 108. The network 108 can include combinations of networks that enable the components in the architecture 100 to communicate with one another. The network 106 may include any one or a combination of multiple different types of networks, such as cable networks, the Internet, wireless networks, and other private and/or public networks. In some instances, the network 108 may include cellular, Wi-Fi, or Wi-Fi direct. Each of the nodes may include components that allow for the communication of data over the network 108.

Generally, FIG. 1 illustrates an example of Distributed Digital Manufacturing (DDM) including Additive Manufacturing (AM). Distributed workflows can be secured with blockchain and distributed ledgers. A three node blockchain network between the OEM design node 102, OEM assembly node 104, and the supplier node 106 is illustrated. Also, the supplier node 106 can be associated with one or more machines (a 3D printer 111 as a non-limiting example) that may create one or more parts based on a model (e.g., CAD) of the OEM design node 102. The supplier node 106 can couple with N numbers of machines for making parts.

By way of example, each of the nodes can maintain a copy of a blockchain ledger. For example, the OEM design node 102 can include a blockchain ledger 110 or digital wallet 112. The copies of ledgers at each node remain synchronized by executing decentralized consensus protocols (e.g., mining) over network 108. Further, each of the nodes can include at least one processor and memory. For example, the OEM design node 102 can include a processor 114 and memory 116. The memory stores executable instructions that can be executed by the processor 114 to perform any of the ASN blockchain features disclosed herein. Each of the nodes can include a communications interface that allows the node to transmit and/or receive data from other nodes. For example, the OEM design node 102 can include a communications interface 118. Where applicable, private data stores may be used on the blockchain ledger, such that two parties may exchange and share information without a third party's knowledge. This method allows data to be shared between pertinent parties without allowing competitors to see important details, such as manufacturing volume data.

To be sure, the digital wallet 112 (residing on each of the nodes individually) can allow two or more nodes to perform transactions, and even microtransactions, with respect to parts or other monetizable/tokenizable assets. In some instances, a real-time payment can be implemented as smart contract escrow. The assets are not smart contract themselves, but smart contracts are codes that work with or change properties such as custody of asset. That is, a requesting (e.g., supplier) node can issue an invoice or request for payment in real-time for completion of the production and quality check of a given batch of parts, or acceptance of parts by the OEM assembly node. A receiving node (e.g., OEM) can arrange for payment of the invoiced amount to the requesting node by transferring remuneration, i.e., tokens from the receiving node's digital wallet to the digital wallet of the requesting node. The payment can be implemented as a smart contract escrow for real-time automation. The value of the token(s) used for payment could be implemented as a native currency implemented on the blockchain platform, or as utility tokens such as ERC-20 which can be shared and exchanged for other tokens, or as a metric in a supplier reward program. In some instances, one node can pay another node according to a license or installment as specified in a smart contract. Thus, the nodes can leverage local digital wallets to facilitate point-to-point transactions for goods or services.

Each step of an end-to-end workflow may be recorded on a blockchain ledger, signed by a cryptographic-credential (e.g., private key) of a node performing the workflow step. Thus, each of the nodes includes at least one cryptographic-credential (e.g., private-public keypair) for signing blockchain ledger entries. The private key is stored locally on the node and the public key is known to the network. Thus, the origin and authenticity of transactions on the blockchain ledger signed by a node's private key can verified by other nodes in the network by decrypting the transactions with the node's public key.

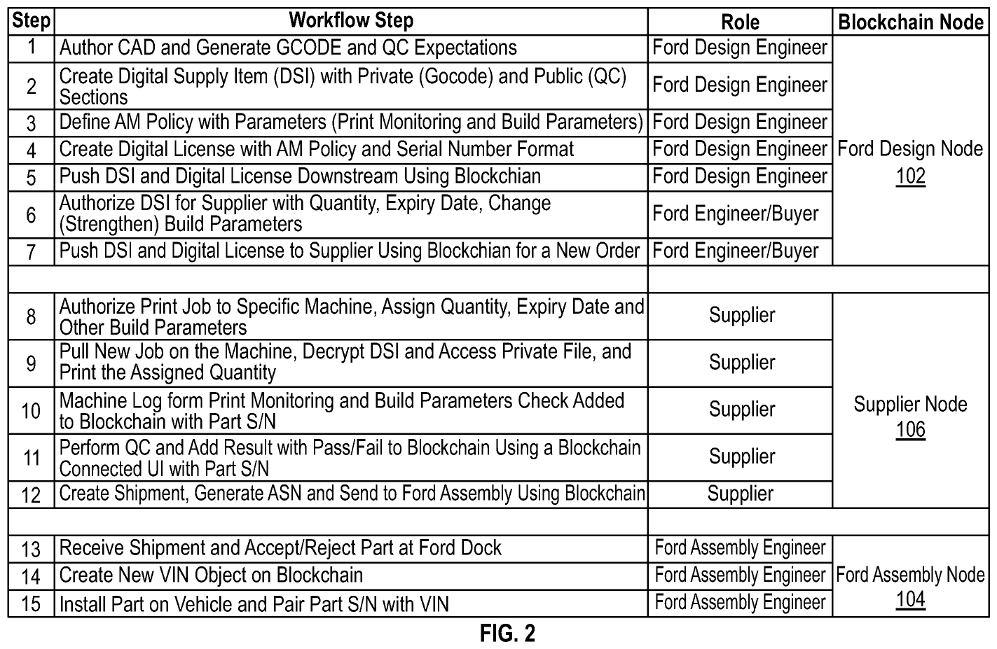

This enables the highest quality, secure audit trail for the DDM workflow. A node may integrate with a three-dimensional printer platform, as well as collect hardware status, in-process monitoring data, and quality inspection data from the supplier site, to be recorded on blockchain. An example workflow is illustrated in FIG. 2. With respect to FIG. 2, steps 1-7 can be performed at the OEM design node 102. Steps 8-12 can be performed at the supplier node 106, and steps 13-15 can be performed at the OEM assembly node 104.

In step 1 a designer creates a Computer Automated Design (CAD) and a GCODE file is generated, along with quality control (QC) expectations. Next, in step 2 a Digital Supply Item (DSI) is created with a private (GCODE) and public (QC) sections. In step 3 an additive manufacturing (“AM”) policy can be designed with parameters (print monitoring and build parameters for example). In step 4 a digital license (DL) is created along with an AM policy and serial number format. The AM policy can include quality control related information or parameters that allow the supplier node 106 to determine if the part has been properly manufactured or not. The DSI and DL can be pushed downstream using blockchain (e.g., adding the DSI and DL to a blockchain ledger). In another embodiment, the DSI file may be stored on an off-chain database (e.g., digital asset store), to help generate a hash of the file contents using a cryptographic hash function, and store the file hash on blockchain, along with the DL for verification.

In step 8 the supplier node 106 can authorize a print job to a specific machine (such as a 3D printer, for example), assign a quantity for a product or part to be manufactured with a machine, an expiry date, and other build parameters for a product or part. In step 9 the supplier node 106 can issue instructions to cause a new printing job on the machine, decrypt DSI, access private file of the DSI, and print the assigned quantity. In step 10 the supplier node 106 can instruct a printer to generate a machine log for print monitoring and build parameters that can be added to a blockchain ledger linked to a part serial number. It will be understood that once a transaction is added to the blockchain ledger, it is visible to all nodes in the network.

In step 11 the supplier node can add QC (Quality Control) results with pass/fail to the blockchain ledger using a blockchain connected UI linked to a part serial number. The supplier node 106 can also orchestrate the creation of shipment instructions, generate an ASN, and transmit the same to the OEM assembly node 104.

In step 12 the OEM assembly node 104 can receive shipments of products as specified by the ASN and accept and/or reject parts. The OEM assembly node 104 can also create a new identifier number, such as a Vehicle Identification Number (VIN) that is stored in an off-chain database, and an obfuscated identity (e.g., Universally Unique Identifier or UUID) that is stored on the blockchain ledger and maps 1:1 with a VIN off-chain, to comply with privacy laws such as General Data Protection Regulation (GDPR), California Consumer Privacy Act (CCPA), etc. The part can then be installed on a vehicle. The part number can then be linked or paired with the VIN for the vehicle and tracked together as part of the vehicle's digital twin.

In some instances, various blockchain events can be facilitated through the architecture. For example, a node can be configured to capture the movement of an authorization license, which allows printing of a part, as it moves from one node to another, such as from the OEM design node 102 to the supplier node 106. A node can also capture the movement of a DSI, which contains important encrypted files, for example as it moves from the OEM design node 102 to the supplier node 106. A node can be configured to confirm that the DSI was authorized to a downstream supplier or a specific printing machine associated with the supplier node 106.

The supplier node 106 can be configured to confirm that the license to print was received by the machine that will be performing the printing. The supplier node 106 may receive an indication or confirm that a selected machine has retrieved the private GCODE file from the digital supply item, which is needed for printing. When printing starts, the supplier node 106 can decrement the available number of prints the selected or assigned machine can perform for this part. The supplier node 106 can determine when printing has started and successfully ended. The supplier node 106 can also determine when files for a specific print job have been archived.

The OEM design node 102 can determine if there is an issue with a license being authorized to a downstream supplier or to a specific machine. The supplier node 106 can determine when printing has been paused and can either be canceled or resumed based on signals received from the printing machine. The supplier node 106 may also receive signals that the printing has been canceled after being paused or generally when printing has failed, as well as when printing has failed. The supplier node 106 can also determine and record when a quality assessment has been performed and a part has passed and/or failed this assessment. Any of the aforementioned events can be recorded on the blockchain ledger.

In a first example use case, for each part, an ASN SC is implemented for use. The ASN SC can be used to perform two checks and flag a part number with accept or reject status. During a parameter and quality check, in-process monitoring parameters and quality check parameters are recorded on the blockchain ledger. The supplier node 106 may not add any parts to the shipment that failed the quality check. However, there could be parts that pass the quality check but have an anomaly in the printing condition (captured as manufacturing failure blockchain event as noted above) or in the quality check being conducted multiple times (if mistakes were made initially). These flagged parts can be accepted with conditions to better assist users in troubleshooting during assembly and/or in the field.

The supplier node 106 can also perform a DSI revocation check. For example, if a part was printed after the DSI for the part is revoked (in the case of a new version release) then the part may be rejected by the OEM assembly node 104 as set forth in the ASN SC even if the part passed the quality check at the supplier node 106 level. If the part was printed before the DSI revocation happened, such an event may not guarantee acceptance of the part by the OEM assembly node 104. The OEM assembly node 104 may prefer to decline any parts from the supplier node 106 inventory. In this case, there would be a smart oracle hosted by the OEM assembly node 104 (an external process that where an ASN SC can be utilized) which would maintain list of current DSI version(s) which would be accepted for each part printed before DSI revocation. The ASN SC can be used to verify the DSI version number with the smart oracle, and flag accept/reject status.

In some instances, DSI revocation and quality check-based part acceptance flagging is conducted using the ASN SC at the end of the supplier workflow of the supplier node 106. This enables the OEM assembly node 104 to have the highest lead time to optimize planning and reduced workload. In other instances, the DSI revocation can be conducted again, when the shipment is received by the OEM assembly node 104. This may result in higher processing and complexity at the OEM assembly node 104, but may enable the OEM assembly node 104 to identify late updates to the part acceptance criteria (e.g., DSI revoked after the part was shipped), and realize less supplier cost and complexity.

When utilizing aspects of the present disclosure, the OEM assembly node 104 receives advanced notice, on blockchain, of what parts are about to arrive. This allows the OEM assembly node 104 to prepare and/or act, as well as provides input data to daily and/or weekly shortage meetings. In some instances, the OEM assembly node 104 may determine that an acceptable pedigree part is going to arrive, even though an old pedigree part may have been manufactured according to all of the rules of that variant at the time that design as given to supplier node 106 (DSI revocation check).

By tying quality rules to the ASN SC, the occurrence score on a PFMEA (Production failure mode effects analysis) for a non-compliant part being shipped to an OEM assembly node is reduced (improved). This is an acknowledgement of the risk reduction to the OEM assembly node of receiving something other than the approved pedigree of part due to the ASN SC's automatic enforcement. This is valuable particularly in a launch (of new product) situation when changes are frequent, other quality systems may not be in place and coordination between OEM assembly node and supplier node may not be optimal. It will be understood that from a system automation perspective, these two nodes may work in a cooperative manner. Coordination may be optimized relative to human communication between two parties which may be stressed during launch, since more people and more changes may be involved when using launch systems instead of long-term production systems.

By designating a subset of parts, with specific measured values within the broader set of acceptable values (i.e., only the upper end of the tolerance interval for some measurement), parts of interest, or “super parts” an OEM can control noise factors input into particular vehicles.

For example, if a particular buildable combination is having issues with NVH (Noise and vehicle harshness, an area important to customer satisfaction), and the tolerance on a supplied part would need to be changed (presumably tightened, at a cost to the OEM) to fix the issue, the OEM can instead define “super parts” that naturally occur in the larger population that meet the tighter tolerance required, then direct those parts to the vehicles of interest. This reduces churn in the supply chain, by eliminating need for a revision bump (to tighten the tolerance), and (if kept private from the supplier) eliminate an opportunity for the supplier to charge for additional engineering, design, and testing.

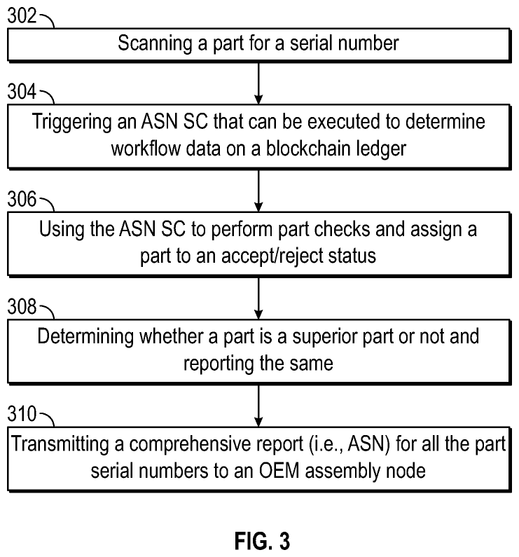

FIG. 3 is a flowchart of another example method where an ASN is utilized. This method can be implemented at the supplier node level and will reference the supplier node 106. The method can be performed using an ASN SC. It will be understood that the supplier may have access to a blockchain connected user interface to create a new shipment. The supplier node 106 may scan each part serial number before adding the parts to the shipment/shipping container. Thus, the method can include a step 302 of scanning a part for a serial number. Once the supplier node 106 completes creating a new shipment, the method may include a step 304 where the supplier node 106 may trigger an ASN SC that can be executed to determine workflow data on a blockchain ledger 106 for each part serial number scanned in step 302, the method can include a step 306 of using the ASN SC to perform part checks and assign a part to an accept/reject status. In some instances, the method includes a step 308 of determining whether a part is a superior part or not and reporting the same. Again, at each step, when data are determined, the data can be stored in the blockchain ledger 106.

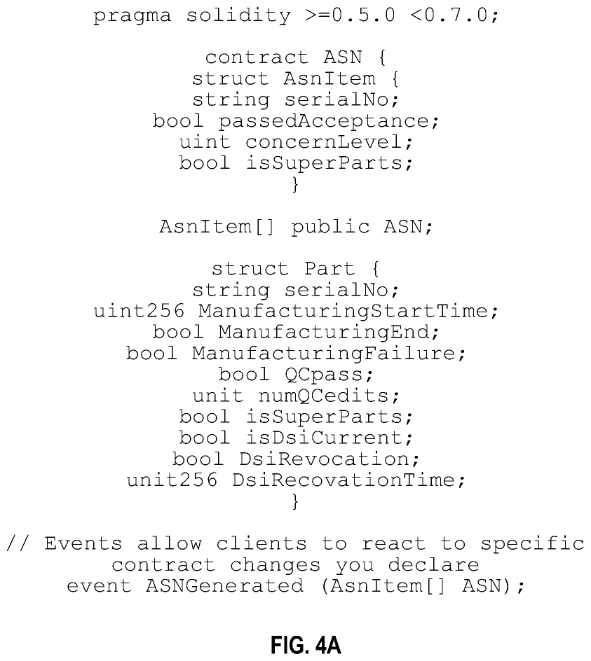

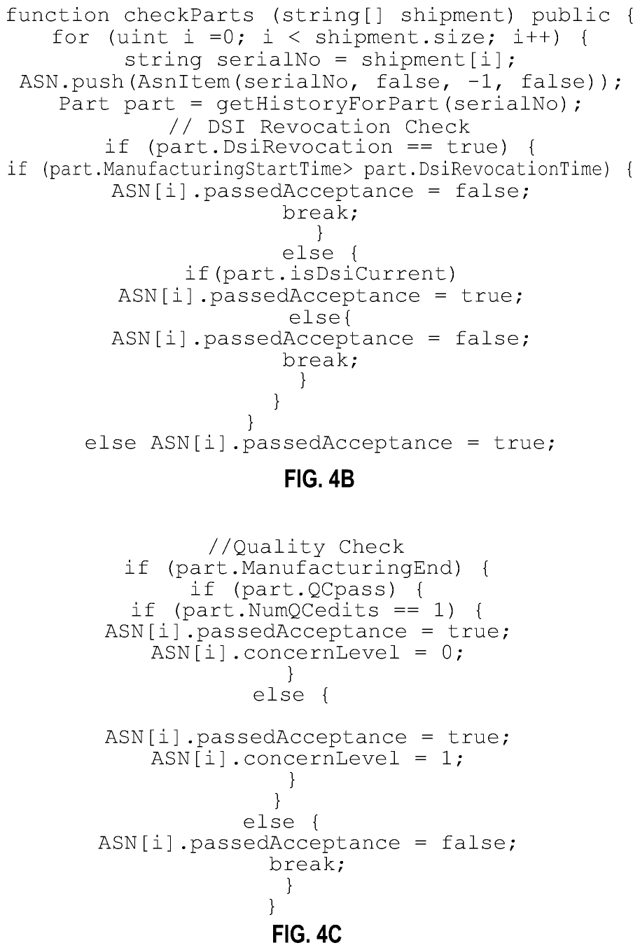

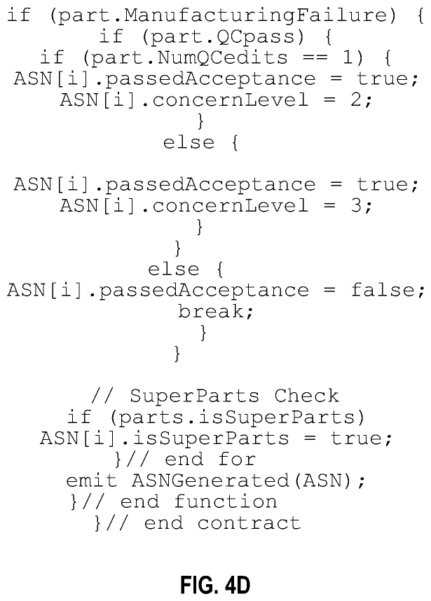

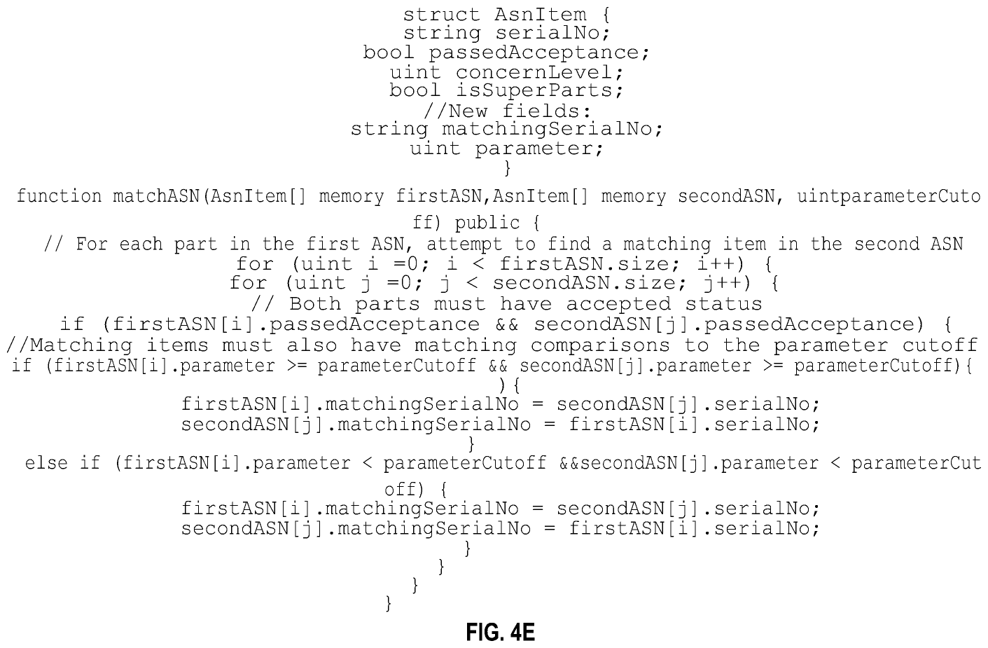

The method can include a step 310 of transmitting a comprehensive report (i.e., ASN) for all the part serial numbers to an OEM assembly node. Based on varying privacy requirements, the ASN could be placed on blockchain itself. The ASN could also be sent to any other desired/authorized endpoint. Thus, the method can be leveraged with or without storing data on a blockchain ledger. That is, an ASN can be transmitted independently of blockchain, but implementing the ASN with blockchain allows for inherent verification of the ASN output based on the secure audit trail provided by the immutability property of blockchain. Note that the ASN SC can use data stored directly on the ledger, or access private data stored on off-chain storage and anchored on blockchain (e.g., via a cryptographic hash function) for future verification. This allows for flexibility to the network participants (e.g., supplier, OEM, etc.) to design and implement effective data management strategies that meet their privacy requirements. FIGS. 4A-4D collectively illustrates code for an example ASN SC. FIG. 4E depicts code for another example ASN SC for matching paired parts. It will be understood that in some embodiments, matching may be based on actual measurements, how those measurements fit into pre-determined ranges (or comparisons to other parts), and a set of rules which are developed based on the overall tolerances.

As noted above, some parts can be classified as superior or super parts. The ASN SC can be used to identify these super parts. It will be understood that parts that fit an additional subset of criteria (these criteria can be defined by the OEM or the supplier) inside the QC process may be referred to as super parts. It is beneficial to flag super parts in an ASN SC by their serial number, so that the parts can be sorted and staged for various reasons such as sending to low volume luxury vehicles or custom order-to-build vehicles. Note that the non-super parts could still be accepted assuming such parts pass the acceptance criteria set forth above, but some advantage would be lost. For example, the parts may assemble, but assembly effort (and thus time and cost) may be higher, or two parts may fit together, but NVH in the form of rattle may be below the maximum acceptable level but higher than optimal target for customer acceptance.

The ASN SC can include a custom filter to flag super parts. This filter can be shared with the supplier node, enabling the supplier node to assist with the sorting (i.e., prepare the shipment in the sorted order such as super parts in a particular container, or truck, or on top of a container, and so forth) if properly incentivized. In some instances, the custom filter is not shared with the supplier node directly but can be applied using a second smart contract executed at the OEM assembly node, when the shipment is received. This introduces additional processing and complexity for the OEM assembly mode; however, this separation preserves the privacy of its custom filters and reduces supplier cost. In sum, the custom filter may be included in a private smart contract that is maintained separately from the advanced shipment notice smart contract.

Further, with respect to super parts, it will be understood that a regular part may possess a full nominal range for relevant dimensions which are illustrated on a part drawing. These dimensions determine the acceptability of the part. For example, a part can have a feature with a primary tolerance range of +/−3 millimeters. A super part, in contrast, may have a tolerance range that is a subset of the tolerance range of the regular part, such as +/−0.5 millimeters located somewhere within the primary tolerance range of the regular part.

These differing tolerance ranges need not be symmetric relative to one another. Merely, the definition of super part tolerance range must be wide enough such that there are enough super parts manufactured during the normal course of regular part manufacturing to cover any volume requirements for the super parts.

The super part ranges may be utilized in luxury vehicles, for example. The inclusion of super parts enables higher perceived quality (e.g., customer perception, NOT basic function). The use of super part designations is improved in situations where nominal super parts interface with assemblies with significant stack-ups (e.g., complex or multi-component assemblies) from multiple other sources. Super parts may also be easier to assemble and assist in line balancing.

In general, focusing on a single set of parts and checking for super status is also advantageous in situations where parts mate with an assembly with significant tolerance stack-ups or contributing components that may not be controlled as one group. An example that could benefit an OEM by reducing manufacturing time could be to make a super part definition for some component interfacing with those assemblies where one half of the tolerance range is known to be easier to assemble (perhaps the minimum material condition requires less operator installation force, so the half of the tolerance range nearest minimum MC is defined to be super). When these parts can be assembled first, followed by other regular (e.g., non-super) parts, operators could get used to a more consistent installation effort or flow such that variance in their installation effort only changes once if parts are used in sequence, or a new operator in training starts with the easier/faster to install parts first before using the rest of the batch.

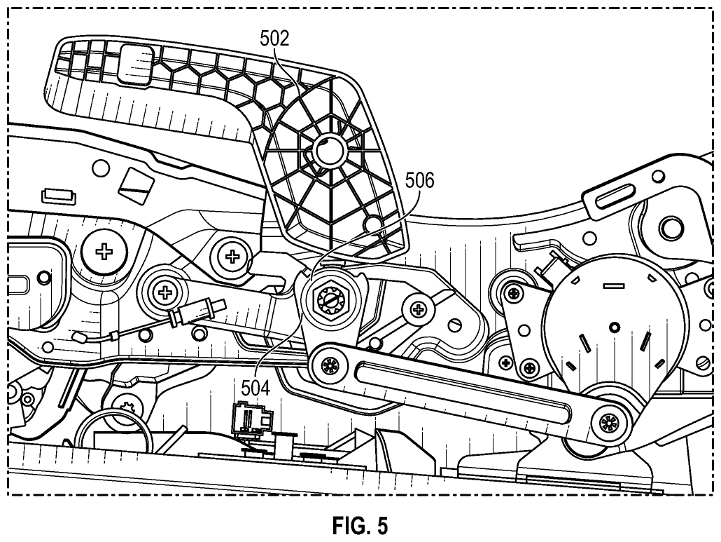

FIG. 5 illustrates an example use case where matching pairs of parts can be effectively managed using aspects of the present disclosure. In FIG. 5, a seat cushion assembly includes a customer interface handle 502 and a seat height adjustment member 504. The handle 502 and seat height adjustment member 504 are configured to mate with one another. More specifically, the handle 502 engages with a structural spline 506 of the seat height adjustment member 504. The mating surfaces of the handle 502 and a structural spline 506 each have a tolerance range that is large enough to have an impact on customer quality perception (visual and/or tactile impact).

In practice, there were fit issues identified during the developmental phase of the product. The structural spline 506 was (within its specifications) constructed on a low end of diameter tolerance, and the handle 502 was (also within its specifications) constructed on a high end of hole diameter tolerance. At the mentioned material condition, the fit was too loose resulting in a perceived quality issue. Issues were also encountered when both parts were designed as specified, but both were constructed with the a maximum material condition.

An acceptable fit was attainable when small holes matched small structures and large holes to large structures. Without a system to track where parts landed within the tolerance zone the interface tolerancing system (associated with an OEM assembly or manufacturer) was updated. The choice was made for the design to be updated for improved customer impact, but the update was less optimal for installation and serviceability, resulting in a risk of breakage during service of useful life.

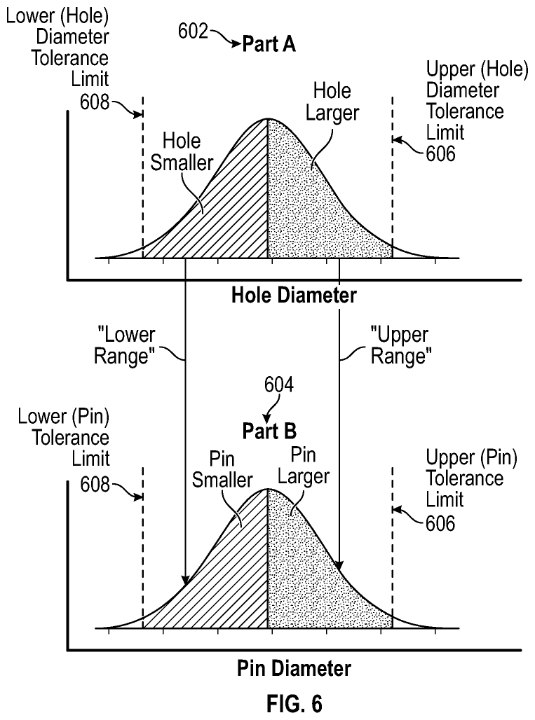

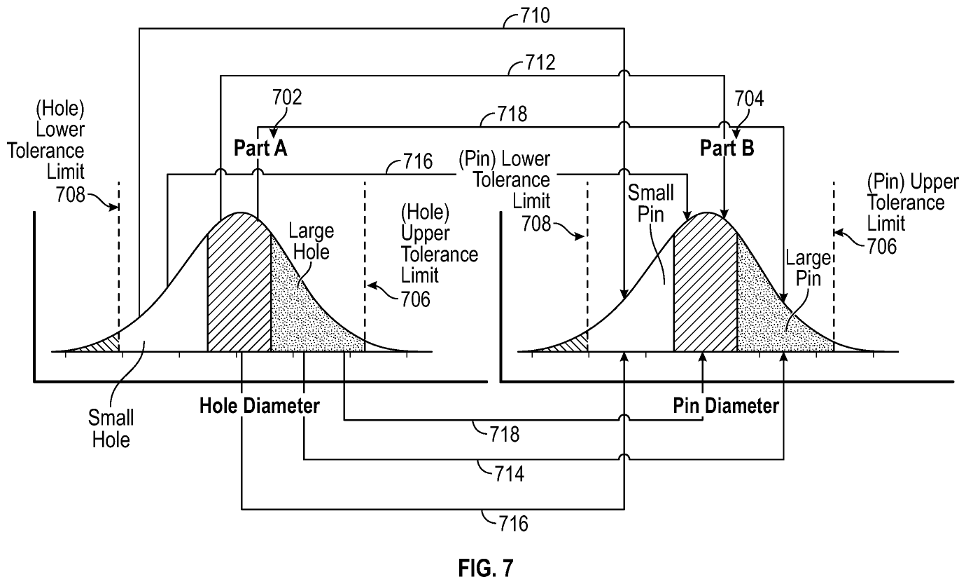

FIGS. 6 and 7 are infographics that illustrate aspects of the present disclosure. In these examples, a pin and a hole are disclosed and utilized as an example for discussing tolerance and matching between complementary parts. However, these teachings can be applied to other parts where match or fit are relevant such as a slot and groove, or width of tabs and insert hole.

In these examples, it will be assumed that the pin and hole are both circular (so diameter is a single dimension, and the only dimension referenced for clarity). If there were two relevant dimensions (such as a rectangular peg with a length and width) the logic still applies, however it would include a distribution for length, a distribution for width, and optionally a correlation between the two. A pair matching algorithm and/or super parts algorithm would be more complicated in this scenario but could also be defined in a similar manner.

The design of the hole and pin may have a particular distribution. A pin or hole may have a specific diameter, and that diameter is known after manufacturing and QC.

In one example, a minimum material condition is +0.3 mm (large hole) and a maximum material condition is −0.3 mm. If the lower range is matched with the lower range, and upper range with upper range, it can be assumed a 0.3 mm of variance maximum (e.g., a nominal hole with the largest possible pin) may be realized, up to 0.6 mm originally (smallest possible hole with smallest possible pin). This does not mean the pin is actually 0.3 mm smaller than the hole, or exactly the same size as the hole. The nominal pin size might be 2.7 mm and hole size 3.3 mm to guarantee a clearance. Or the nominals may actually be equal. It is understood that a combination of the nominals and the range of tolerances (where the vertical dashed lines are) drives the “feel” of a fit (and also contributes to wear characteristics).

Requirements with respect to super parts may have their own specific considerations. The distributions for dimensions related to a super part may be represented under a binomial curve. Parts falling outside of tolerance regions on the binomial curve may be scrapped. If the low end of the tolerance is the region useful as super parts, this may result in fewer super parts. If the area nearer (or even including) the distribution curves center is the super parts more super parts may be produced, even if the amount of acceptable variance is the same. In one example, a binomial graph may be created for shaft diameters. To be sure, distributions may not always be binomial, they frequently are for many manufacturing processes. Frequently, processes are generally centered either on the nominal if the tolerance is symmetric, or in the middle of the tolerance range if it's not (e.g., 3.0 mm +0.3/−0.1 probably centers on 3.1 mm)

Generally, parts closer to the nominal or middle of the binomial curve are produced naturally in higher volume. When defining super parts, a combination of considerations may be used such as a desire for wide enough definition, enough parts overall, and a well-placed zone to make sure enough super parts are produced. Similar concepts apply to matched pairs

FIG. 6 is an infographic that illustrates another example of matching paired parts with a simple pin and hole interface. A first part (Part A) has a hole diameter 602. A second part (Part B) has a pin diameter 604. The pin of the second part interfaces with the hole of the first part. The pin diameter 604 has an upper tolerance limit 606 and a lower tolerance limit 608. In this example, the hole of the first part matches when the hole diameter 602 corresponds with the upper end of the upper tolerance limit 606, and the pin diameter 604 is also on the upper end of the upper tolerance limit 606. Broadly, an example goal involves matching mating components that fall in complementary parts of their tolerance ranges in order to reduce the average difference between the actual measurements of the pins and holes. For example, larger holes go with large pegs, smaller holes with small pegs. Though the entire tolerance range was defined such that any two parts would meet the minimum functional requirements, optimally matched pairs can reduce wear, deliver more consistent customer use efforts, reduce installation forces, and so forth. Again, this is a basic example of a matched pair scheme, and more advanced examples could have more division in the tolerance range, and more acceptable pair combinations, as illustrated in FIG. 7.

In FIG. 7, a first part (Part A) has a hole diameter 702. A second part (Part B) has a peg diameter 704. The pin of the second part is configured for insertion into the hole of the first part according to specified tolerances. The peg diameter 704 has an upper tolerance limit 706 and a lower tolerance limit 708. The arrows, such as arrows 710, 712, and 714 indicate segments of the tolerance limit that are to be used, where each segment of the tolerance range of part A map to a range in part B.

In more complex, but robust to shifting the output of component manufacturing changes or drift, part A components in a given range may map to multiple possible part B components as identified by cross arrows 716 and 718, where Part A components can map to a part B component in a tolerance zone within one of that of part A.

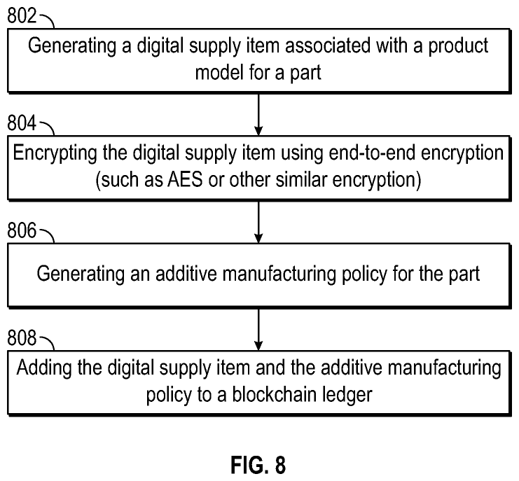

FIG. 8 is a flowchart of an example method of the present disclosure. Generally, this method can be performed by an agent of the OEM. The method includes a step 802 of generating a digital supply item associated with a product model for a part. This can be accomplished once a model or design for the part has been approved and received. Next, the method includes a step 804 of encrypting the digital supply item using end-to-end encryption (such as AES or other similar encryption). The method can also include a step 806 of generating an additive manufacturing policy for the part. The additive manufacturing policy describes the preferred three-dimensional manufacturing parameters for the product.

The method can include a step 808 of adding the digital supply item and the additive manufacturing policy to a blockchain ledger. It will be understood that a supplier can authorize a print job for the part, decrypt the digital supply item from the blockchain ledger, and print the part using the digital supply item on a three-dimensional printer, according to the additive manufacturing policy.

In some instances, the method can include generating a digital license for the supplier with the additive manufacturing policy and a serial number format for the part, as well as adding the digital license to the blockchain ledger. The method can also include the supplier adding a machine log obtained from the three-dimensional printer to the blockchain ledger.

The method can include steps such as adding quality control results to the blockchain ledger, where the quality control results are indicative of whether the part passed or failed quality control parameters of the additive manufacturing policy. The quality control results can be saved and able to be analyzed later by other agents to determine pass/fail. The quality results could be discrete (0, 1, 2), binary (pass/fail, true/false) or a value from a continuous distribution (1.2295).

In some instances, QC results could indicate that a part passed or not (“the height was within bounds: PASS” or “the height was too tall: FAIL”) or the QC results could be descriptive of some parameter (“height=5 mm”) and it would be up to another party to determine if that data indicates a pass or fail. In some cases, the QC data might be saved for future reference and not checked if a smart contract is not implemented to look at that specific piece of data.

In some instances, the method includes generating an advanced shipment notice smart contract and transmitting the advanced shipment notice smart contract to another party on the blockchain network (or a member of the manufacturing value chain) such as a manufacturer, as well as sending a shipment that includes the part to the manufacturer along with the advanced shipment notice smart contract.

An OEM assembly node (an individual or robotic system) can receive the shipment and execute the advanced shipment notice smart contract to accept or reject the part. The advanced shipment notice smart contract further determines if the part passed or failed a quality control check. The method can also include executing the advanced shipment notice smart contract to perform a digital supply item revocation check to determine if the digital supply item is active or revoked.

The method can include executing the advanced shipment notice smart contract to determine if the part is a super part as identified by a part serial number. It will be understood that the super part may have a specific and narrow tolerance compared to another part that is used along with the part in an assembly. The super part can be identified by a custom filter in the advanced shipment notice smart contract. As noted above, the custom filter may be included in a private smart contract that is maintained separately from the advanced shipment notice smart contract.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
generating a digital supply item associated with a product model for a part;
encrypting the digital supply item;
generating an additive manufacturing policy for the part; and
adding the digital supply item and the additive manufacturing policy to a blockchain ledger,
wherein a supplier can authorize a print job for the part, decrypt the digital supply item from the blockchain ledger, and print the part using the digital supply item on a three-dimensional printer, according to the additive manufacturing policy.

2. The method according to claim 1, further comprising generating a digital license for the supplier with the additive manufacturing policy and a serial number format for the part.

3. The method according to claim 2, further comprising adding the digital license to the blockchain ledger.

4. The method according to claim 1, further comprising adding a machine log obtained from the three-dimensional printer to the blockchain ledger.

5. The method according to claim 1, further comprising adding quality control results to the blockchain ledger, the quality control results being indicative of whether the part passed or failed quality control parameters of the additive manufacturing policy.

6. The method according to claim 1, further comprising generating an advanced shipment notice smart contract and transmitting the advanced shipment notice smart contract to another party on a blockchain network.

7. The method according to claim 6, further comprising sending a shipment that includes the part to the another party along with the advanced shipment notice smart contract.

8. The method according to claim 7, further comprising:
receiving the shipment; and
executing the advanced shipment notice smart contract to accept or reject the part.

9. The method according to claim 8, wherein the advanced shipment notice smart contract further determines if the part passed or failed a quality control check.

10. The method according to claim 9, further comprising executing the advanced shipment notice smart contract to perform a digital supply item revocation check to determine when the digital supply item is active or revoked.

11. The method according to claim 10, further comprising executing the advanced shipment notice smart contract to determine if the part is a super part as identified by a part serial number, the super part falling within a specific and narrow tolerance compared to another part that is used along with the part in an assembly, the super part being identified by a custom filter in the advanced shipment notice smart contract.

12. The method according to claim 11, wherein the custom filter is included in a private smart contract that is maintained separately from the advanced shipment notice smart contract.

13. A system, comprising:
a first node comprising a processor and memory, the processor executing instructions stored in the memory to:
generate a digital supply item associated with a product model for a part;
encrypt the digital supply item;
generate an additive manufacturing policy for the part; and
add the digital supply item and the additive manufacturing policy to a blockchain ledger;
a second node comprising a processor and memory, the processor executing instructions stored in the memory to:
authorize a print job for the part;
decrypt the digital supply item from the blockchain ledger;
cause the part to be printed using the digital supply item on a three-dimensional printer, according to the additive manufacturing policy;
generate an advanced shipment notice smart contract that includes at least quality control data for the part; and
execute the advanced shipment notice smart contract; and
a third node comprising a processor and memory, the processor executing instructions stored in the memory to execute the advanced shipment notice smart contract to determine when the part is a super part or when the part is matched with another part based on a dimensional measurement.

14. The system according to claim 13, wherein the first node is configured to generate a digital license for the second node with the additive manufacturing policy and a serial number for the part.

15. The system according to claim 14, wherein the first node is configured to add the digital license to the blockchain ledger.

16. The system according to claim 13, wherein the second node is configured to add a machine log obtained from the three-dimensional printer to the blockchain ledger.

17. A method, comprising:
receiving an advanced shipment notice smart contract and a part, the advanced shipment notice smart contract being executed;
executing the advanced shipment notice smart contract to determine when the part is a super part as identified by a part serial number in a digital supply item, or when specific dimensions of the part fall within a specific and narrower than a primary tolerance compared another part that is used along with the part in an assembly, the part being identified as the super part by a custom filter in the advanced shipment notice smart contract; and
accepting or rejecting the part based on whether the part is the super part and/or based on quality control data included in the advanced shipment notice smart contract.

18. The method according to claim 17, wherein the custom filter is included in a private smart contract that is maintained separately from the advanced shipment notice smart contract.

19. The method according to claim 17, further comprising:
executing the advanced shipment notice smart contract to perform a digital supply item revocation check to determine when the digital supply item for the part is active or revoked; and
adding a digital license to a blockchain ledger along with the digital supply item for the part.

20. The method according to claim 17, further comprising feeding the custom filter into another algorithm which, dictates a specific order for the part to be shipped in, or arranged by, or otherwise sorted.
